(19) United States
(12) Patent Application Publication
(10) Pub. No.: US 2003/0127825 A1
(43) Pub. Date: Jul. 10, 2003

(54) FOLDING STRUCTURE FOR A BICYCLE

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/038,607

(22) Filed: Jan. 8, 2002

(51) Int. Cl. B62K 15/00

(52) U.S. Cl. 280/287; 280/286

(57) ABSTRACT

A folding structure for a bicycle comprises a connector at the front end of a rear fork with a hole on the top side, the upper strut has a fixture with a hole corresponding to the hole of the connector to secure the connector thereat with a bolt, the opposite side of the fixture has a recess which secures a handle thereat, the rear fork also comprises a confining device, which allows the rear fork to swing with respect to the seat strut after the shock absorber is disengaged, thus save storage space.

### BACKGROUND OF THE INVENTION

1. Field of the Invention

This invention relates to a bicycle, more particular to a bicycle with a foldable structure.

2. Description of the Related Prior Art

Owing to the public parking space is less to find for automobile drivers to find, many cities are encouraging people to ride bicycles to work and for leisure. In order to make bicycle riders more comfortable, a shock absorber is installed between the rear fork and the main frame of the bicycle, one of the bicycle, which has shock absorber installed, is designed to fold for carrying consideration. This design is to connect the top end of the shock absorber to the seat strut with a quick-release connector, and the bottom end to the rear fork, thus by releasing the quick-release connector, the top end of the shock absorber may be disengaged, and the rear fork may be folded.

However, this design is to fold the rear tire in a 180 degrees and underneath the upper strut, the size after folding is still too big, and furthermore, the connecting points of the shock absorber with respect to the rear fork and the upper strut are easy to wear out after and out of alignment.

The inventor has designed the present product to correct all of the above shortcomings.

### SUMMARY OF THE INVENTION

It is a primary object of the present invention to provide a folding structure for a bicycle, which forms a compact size when folding for easy carrying and storage.

It is another object of the present invention to provide a folding structure for a bicycle, which structure is more solid and can ride steadily.

It is a further object of the present invention to provide a folding structure for a bicycle, which is easy to install and disengage.

### BRIEF DESCRIPTION OF THE DRAWINGS

FIG. 1 is an exploded view of the bicycle incorporated with the present invention;

FIG. 2 is a side view, showing the bicycle being installed with the shock absorber of the present invention;

FIG. 3 is another side view of FIG. 2;

FIG. 4 is a side view showing a first step of disengaging the shock absorber;

FIG. 5 is a side view showing a second step of disengaging the shock absorber; and

FIG. 6 is another side view of the present invention, showing the shock absorber being disengaged and the rear fork is folded to the front end underneath the upper strut;

### DETAILED DESCRIPTION OF THE PREFERRED EMBODIMENT

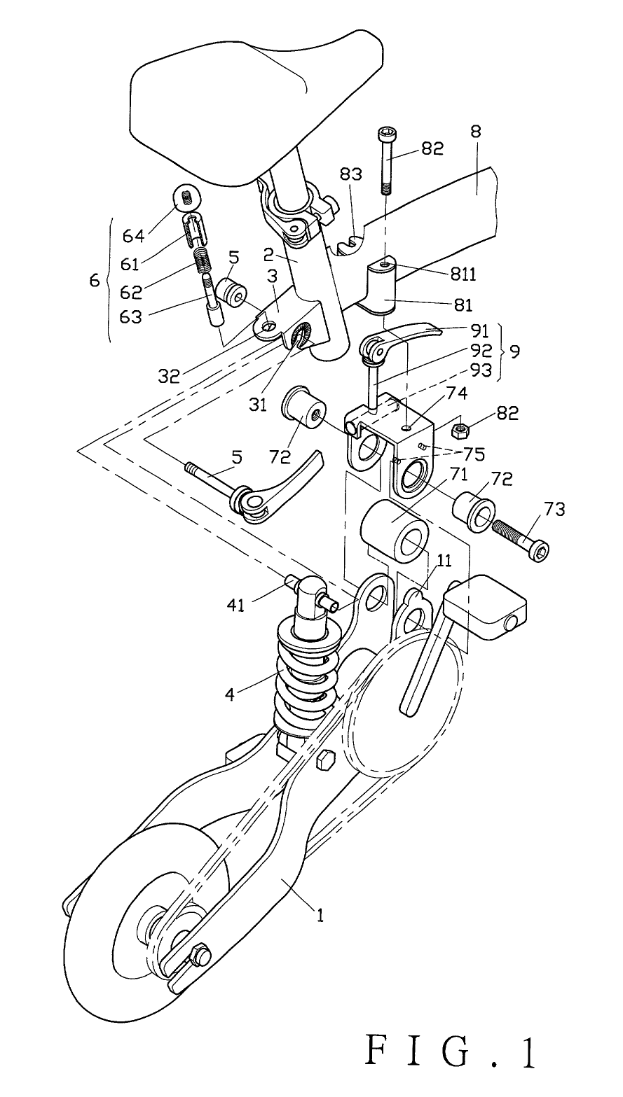

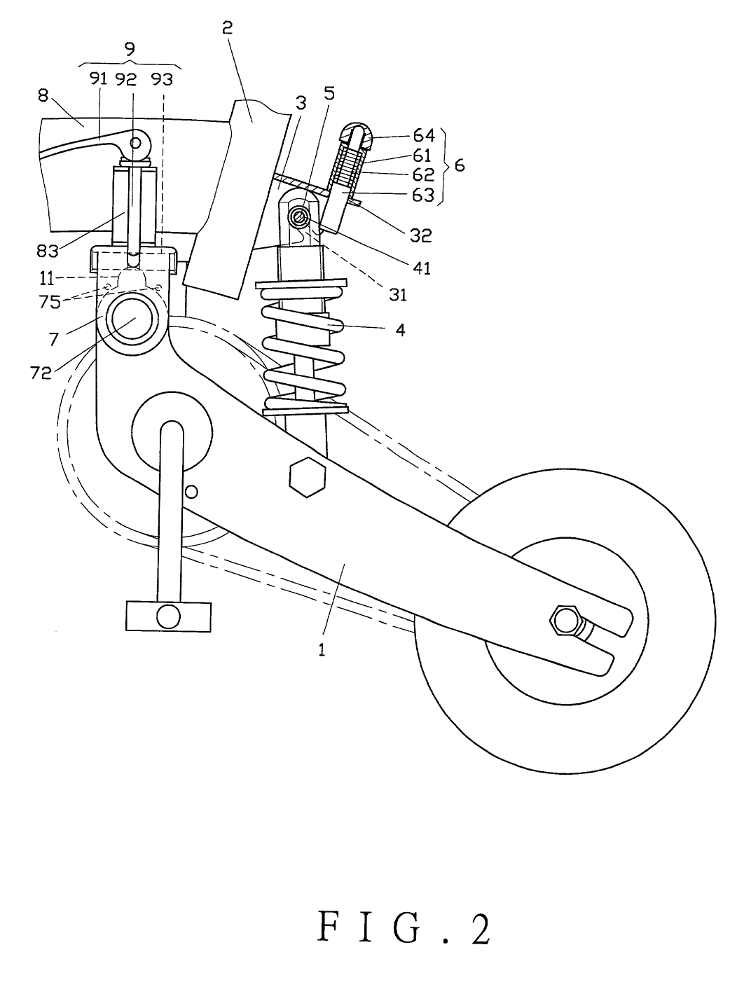

The folding structure for a bicycle comprises a rear fork 1, a seat strut 2 having a fixture 3 at its rear end, a shock absorber 4 having the bottom end of the shock absorber 4 is secured to the center of the rear fork 1, while the top end of the shock absorber 4 is secured to the fixture 3 with a quick-release bolt 5. The fixture 3 comprises a pair of recesses 31 at respective sides for a shaft 41 to extend there through and seat in the fixture 3, while the quick-release bolt 5 is sleeved through the shaft 41 and secure in the fixture 3, which press tighten the top end of the shock absorber 4 in the fixture 3, as shown in FIGS. 1 and 2. In order to secure the top end of the shock absorber 4 at place, a stopper 6 is adapted, which comprises a sleeve 61 in the fixture 3 having a shaft 63 sleeved with a spring 62 thereon with one end of the shaft 63 extending upwardly and secured with a cap 64 thereat. The fixture 3 comprises a hole 32 for the shaft 63 to extend there through. The other end of the shaft 63 is in a constant contact with the top edge of the shock absorber 4, thus prevent the shock absorber 4 from disengagement.

The rear fork 1 has a connector 7 at its front portion having a center shaft 71 seating on the rear fork 1 with a pair of side shafts 72 inserted into the connector 7 and sleeved into the center sleeve 71 and then secured by a bolt 73. The connector 7 comprises a hole 74 at one side of the top surface, which corresponds to a hole 811 of a fixture 81 for a bolt 82 to insert there through for securing purpose. The fixture 81 of an upper strut 8 has a recess 83 at the opposite side with respect to the hole 811 adapted to receive a shaft 92 of a locking device 9. The top end of the shaft 92 has a handle 91 and the bottom of the shaft 92 is threaded to connect with another shaft 93, the connector 7 may be loose or tight. The connection between the rear fork 1 and the connector 7 requires a slight differential allowance in order to disengage the shock absorber 4, this is done by forming a rib 11 protruding from one top end of the rear fork 1, and the connector 7 has a pair of pins 75 corresponding to the rib 11, that allows the connector 7 to swing within the pins 75.

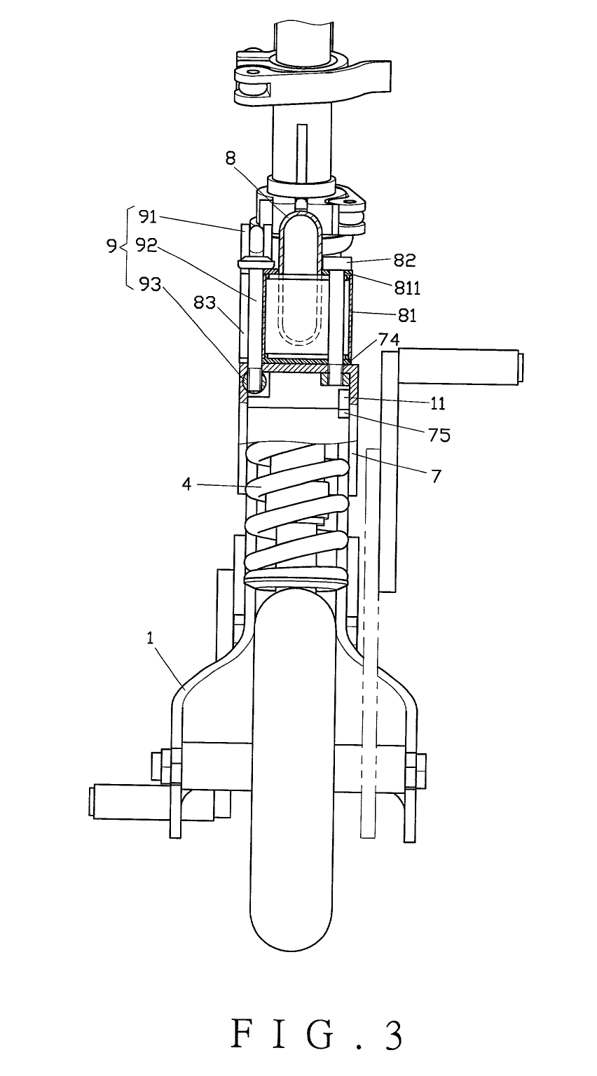

To secure the shock absorber 4, align the connector 7 onto the fixture 81 with the shaft 92 sticking inside of the recess 83 and the bolt 82 insert through the hole 811 and the hole 74, thus the rear fork 1 is secured to the fixture 81 of the upper strut 8 through the connector 7, as shown in FIG. 3.

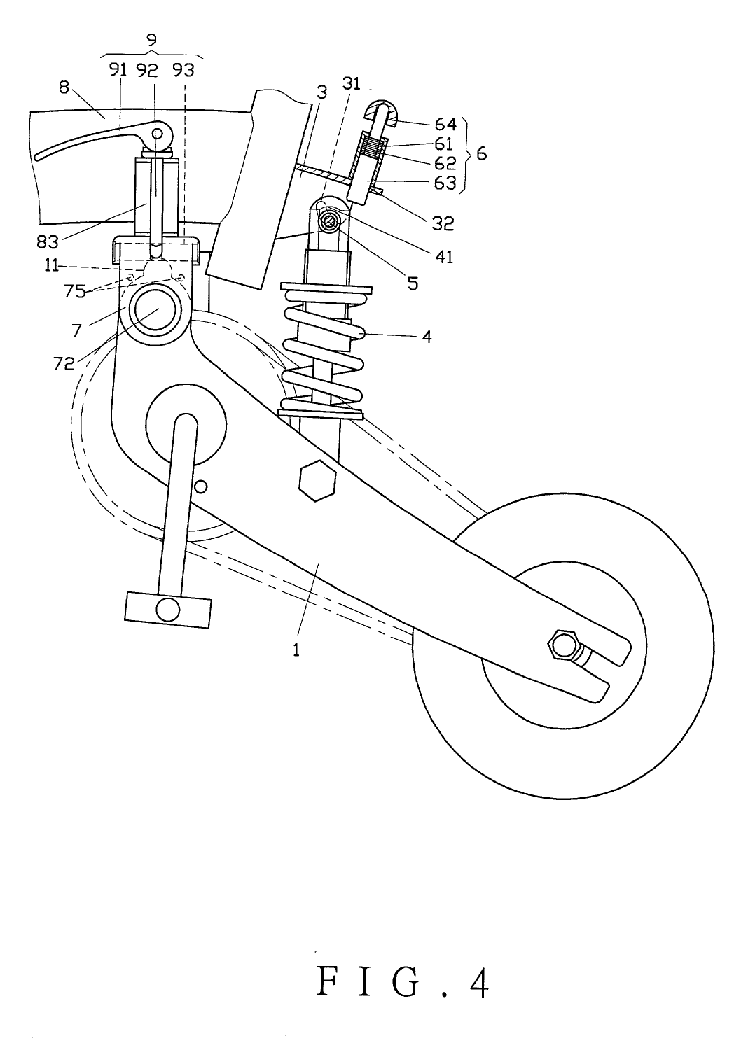

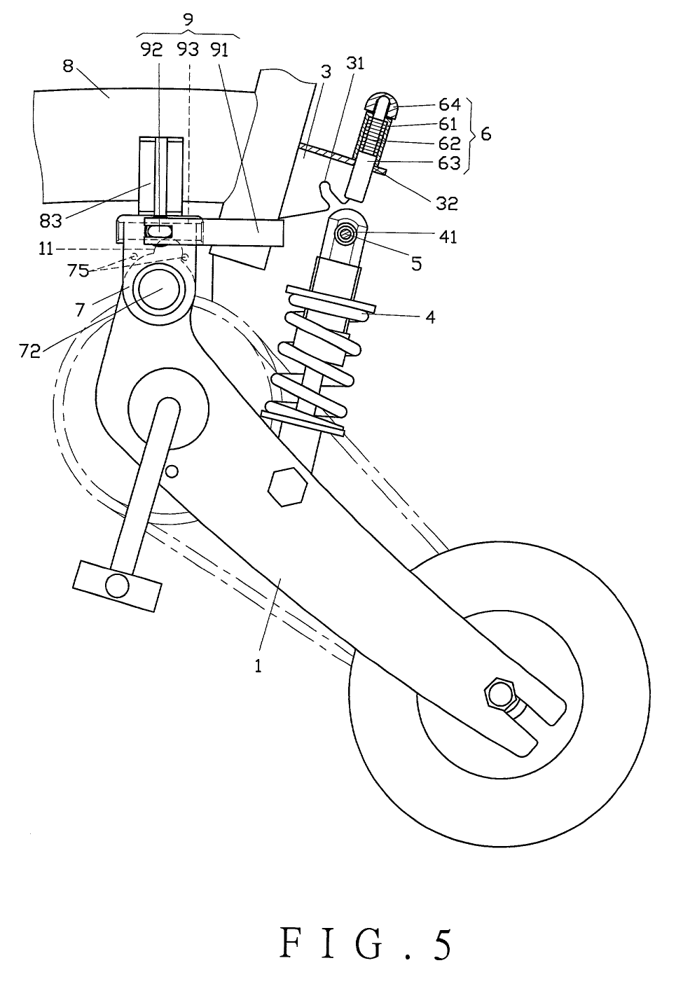

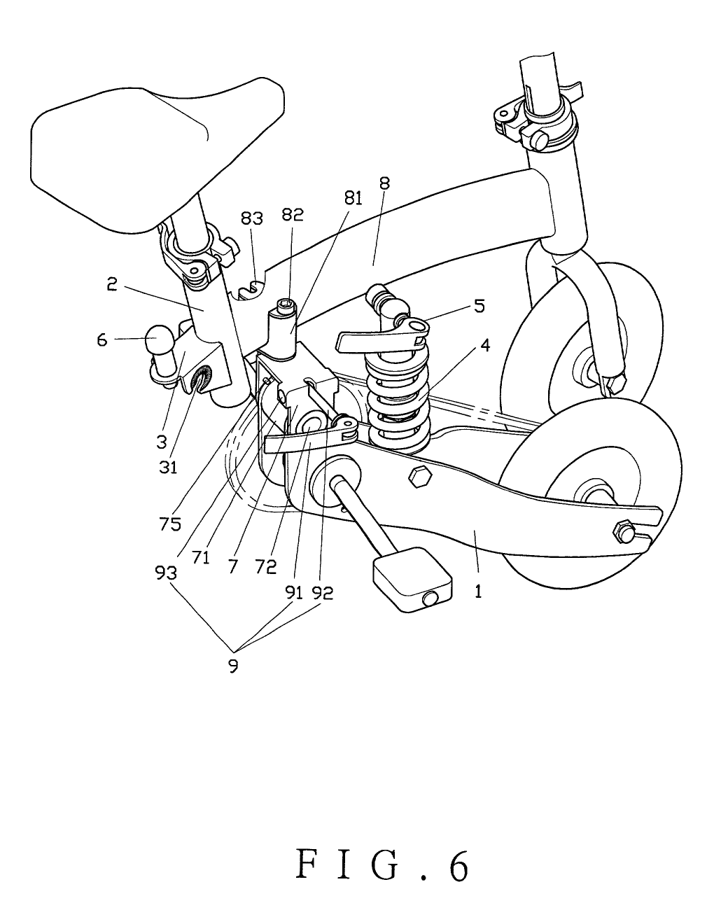

To fold the bicycle, as shown in FIG. 4, pull the cap 64 of the stopper 6 upwardly which brings the shaft 63 upwardly and away from the top end of the shock absorber 4, as shown in FIG. 5, whereas the rear fork 1 may be pull down slightly, which enabling the quick-release bolt 5 and the shaft 41 to slide along the recesses 31 and detached from the fixture 3. The cap 64 at this moment may be released so that the shaft 63 is urged by the spring 62 to return to its original position. Whereas, the connector 7 may be swinging along the rib 11, and then operate the handle 91 to release the locking device 9, as shown in FIG. 6, and the rear fork 1 is free to turn to the front and the folding procedure is completed.

I claim:

1. A folding structure for a bicycle of the present invention comprising a rear fork and a seat strut, wherein a shock absorber being connected with its bottom end to said rear fork and its top end to said fixture through a quick-release bolt and a shaft, and characterized in that:
said rear fork having connected with a connector with a hole at top one side and a recess at the opposite side, the font end of said seat strut comprising a fixture having a hole at one side corresponding to said hole of said connector for receiving a bolt there through so as to secure said connector thereat, and a recess at opposite side of said fixture adapted to secure a handle of a locking device thereat, a slight differential allowance being formed between said connector and said rear fork allowing said rear fork to swing upon said shock absorber being disengaged from said fixture and to fold forwardly.

2. The folding structure for a bicycle, as recited in claim 1, wherein said handle being connected to the top end of said shaft, which having its bottom end secured to said connector, said locking device comprising a handle extending from the top of said shaft and the bottom end threaded to another shaft.

3. The folding structure for a bicycle, as recited in claim 1, wherein said rear fork comprising a rib protruding from one top end thereof, and said connector also comprising a pair of pins corresponding to said rib of said rear fork, when said connector swinging along said rear fork, said pins and said rib confining swinging movement.
